(19) United States
(12) Patent Application Publication
(10) Pub. No.: US 2007/0061753 A1
(43) Pub. Date: Mar. 15, 2007

(54) Letter and word choice text input method for keyboards and reduced keyboard systems

(75) Inventors: Edwin Ng, Singapore (SG); Joo Seng Julian Oh, Singapore (SG); Chin Foo Ken Tan, Singapore (SG)

Correspondence Address: MARSHALL, GERSTEIN & BORUN LLP, 233 S. WACKER DRIVE, SUITE 6300, SEARS TOWER, CHICAGO, IL, 60606, US

(73) Assignee: XRGOMICS PTE LTD, SINGAPORE (SG)

(21) Appl. No.: 10/564,901

(22) PCT Filed: Jun. 30, 2004
(86) PCT No.: PCT/SG04/00190

§ 371 Date: Sep. 11, 2006

(30) Foreign Application Priority Data
Jul. 17, 2003 (SG) 20034112-6

(51) Int. Cl. G06F 17/00

(52) U.S. Cl. 715/816

(57) ABSTRACT

A method for entering text efficiently by providing letter or word choices. The method includes letter choices to aid inputting accented, diacritic or special characters and a more efficient method to suggest word completion choices including words with accented, diacritic or special characters. This method can be used to enhance any existing text input systems, even reduced keyboard systems. The method also includes a more efficient method to select and input the letter or word choices. This allows for hybrid keyboard systems where physical keys are used in concert with a screen input system to input the letter or word choice.

### FIELD OF THE INVENTION

This invention relates to using letter and word choices to enhance text input especially on screens with sensors, sensor pads or pen based inputting on any keyboard systems or arrangement of characters. It also allows for quick selection of choices to be implemented seamlessly for reduced keyboard systems, e.g. TenGO (Singapore Patent Application 200202021-2), to complement the ambiguous and unambiguous keystroke methods. The word choice text input method enables efficient word prediction, word completion and word selection, while the letter choice text input method allows for efficient input of accented, diacritic and other special characters. This invention is also especially relevant for touch screen or soft-key text-inputting applications in mobile devices, mobile phones, handhelds, PDAs, pocket computers, tablet PCs, sensor pads or any pen-based, virtual keyboard systems, or even hybrid physical keyboard and glove-based systems.

### BACKGROUND

The growth of PDAs, handhelds and mobile devices has been nothing short of phenomenal. Almost everywhere you turn and everyone is carrying a mobile device of sorts. One of the advents of the new era is the surge of online text based communication. Online text based communication, started with the computers and the Internet and continued to gain acceptance and popularity with Short Message Service (SMS). Email is now a de facto form of communication for both personal and business purposes and compact electronic devices are getting smaller, have more functionality and are more integrated. The singular direction headed by mobile phones, handhelds, PDAs and pocket computers is that it must have online text based communication in one form or another, be it emails, SMS or instant messaging (IM).

For text input, pen-based paradigm has dominated the handheld market, but there is a parallel trend towards using keyboard-based technology. Pen-based input uses a stylus, finger or object to either tap on a virtual keyboard on screen or scribble on screen using handwriting recognition to decipher the “digital ink” left by the scribbling. Pen-based tapping suffers from small virtual keyboard buttons being represented on screen or larger buttons which compromises display areas while pen-based scribbling (handwriting) though seemingly “more natural” is slow and not accurate enough to fulfil high user expectations. However, the ultimate bottleneck of handwriting input lies in the human handwriting speed limit. It is very difficult to write legibly at a high speed. Speed and efficiency wise, keyboard entry is still the fastest and most convenient for text based communication. Thus, with the heavy and increasing demand for online text based communication, many device manufacturers are forced to using a miniature full-sized QWERTY keyboard. The miniature keyboard, though visually appealing, leaves much to be desired for anything more than casual text input as the keys are too small and too close together. Because of this, reduced keyboard systems using predictive text input are another alternative that seems promising because of the limitation of space and larger buttons, but the problem arises when needing to cycle through word choices or letter choices that share the same keystroke sequence or keystroke. This usually requires a cycle button, which is a legacy for reduced keyboard systems, and it is usually quite tedious to cycle through individual word or letter choices. Examples of reduced keyboard systems are described in U.S. Pat. Nos. 5,818,437; 5,945,928; 5,953,541; 6,011,554; 6,286,064 and 6,307,549, the disclosures of which are herein incorporated by reference, and the unambiguous text input methods of multi-tap, two-keystroke or multiple-stroke interpretation are described in U.S. Pat. Nos. 6,011,554 and 6,307,549 for reduced keyboard systems.

There have been various attempts to improve text inputting like incorporating a forward prediction engine for the pen-based tap method. The words suggested by the forward prediction engine are usually generic (frequency and choice of words are compiled from generic references like articles, research, etc.) and sorted by a frequency field. Therefore, besides breaking the flow of normal typing to look at the suggested words, the words suggested are often not suitable or intelligent. Because of its ineffectuality, you only see forward prediction in soft keyboards where it is very difficult and cumbersome to type and not fully integrated in other pen-based methods like handwriting or letter recognition text input methods. Thus, it is not surprising that users are currently using mobile text-based applications like emails and word processing for reading only and not for writing. Text inputting on mobile devices are most of the time limited to only short messages, short notes and filling contact information.

Also, existing text input methods do not provide easy methods to input accented or diacritic characters. This difficulty not only applies to mobile text input solutions but also to conventional keyboards as well, where you require pressing special auxiliary keys to select the accented or diacritic characters.

In the present invention for text input, we provide an easy and intelligent method to present letter and word choices to enhance text input. Letter choices are very efficient in aiding entry of accented or diacritic characters and word choices are presented in a dynamic, intelligent and personalised manner to be more useful and relevant. In combination (both letter choice and word choice), it is very easy for the word choice method to present words with accented or diacritic characters without the need to type in any accented characters or diacritic characters directly. The beauty of the design is that it can be implemented on any text input systems, virtual, keyboard, pen-based, glove-based, sensor-based or otherwise. The letter choice and word choice can also be implemented independently to enhance various text input methods, though they usually work much better together.

The letter and word choice text input method is especially powerful when used with reduced keyboard systems because of its intelligent choice suggestions. Because reduced keyboard systems already come with its own ambiguity, thus needing to present its own word choices to resolve this ambiguity, it is often not appropriate to supplement with another set of suggestive word choices (e.g. forward prediction). But with an intelligent word choice system, the suggested word choice is now more accurate and relevant and because it is dynamic, it can quickly customise and personalise to the user and subject matter making it useful even for reduced keyboard systems. Also, the additional word choices are presented in a predetermined choice window that occupy only a small additional space but still remain highly effective and accessible. Our invention is suggested with a reduced keyboard arrangement/system that can be used with the letter and word choice text input method.

Letter choice options, like word choice in forward prediction engines described above, for text inputting itself is not new and has been used to provide choices to resolve ambiguous input of multi-character keys in reduced keyboard systems for unambiguous text entry of characters. In our invention, we take it further to even aid both unambiguous input of single character keys and unambiguous input of multi-character keys, as described in Singapore patent application 200300895-0 for unambiguous scribing of characters of mufti-character keys, by providing an easy option of keying in special characters associated with the inputted character.

With a great letter and word choice method, you would also need an efficient choice selection method that enables the choices to be efficiently selected, changed and used. The present invention besides allowing for choices to be selected via the conventional input method (e.g. keyboard) and screen input method (e.g. touch screen) it also introduces a new concept which is hybrid text inputting, which incorporates both conventional text inputting and screen text inputting (e.g. typing with the conventional keyboard yet being able to select letter and word choices directly via a touch screen).

### SUMMARY

An aspect of the invention provides for a method for a text input system, wherein to input a data value or data symbol on a keyboard using a letter and word choice text input method comprising the steps of inputting a character using the keyboard; matching the unambiguous character inputted with a stored keystroke in a database, the stored keystroke having associated letter choices stored in the database wherein the associated letter choice is a data value or a data symbol associated with the stored keystroke; matching the beginning of the keystroke sequence with a stored keystroke sequence in a database, the stored keystroke sequence having associated word choices stored in the database wherein the associated word choice is a data value or a data symbol associated with the stored keystroke sequence; displaying as text input the data value or data symbol assigned to the inputted character or keystroke sequence; displaying the matching letter choices associated with the character; and displaying the matching word choices associated with the beginning keystroke sequence.

An embodiment may include letter choices which are accented or diacritic variations of the associated character. It may also include word choices that contain accented or diacritic characters but the stored keystroke sequence only contains the corresponding normal characters or unaccented representation.

Another embodiment further comprises the step of selecting a new choice and displaying the new choice as text input over the previous text displayed. If the same choice is selected again, to display the data value or data symbol of the choice as another new text input.

A further embodiment of the method wherein the choices are displayed in a predetermined window or display area. Additionally, the predetermined window or display area is on a screen input system and the choices can be selected directly from the screen. Also, short-cut keys could be associated or displayed besides the choices. Furthermore, by pressing the short-cut key, the choice associated with the short-cut key will be displayed over the previous text displayed.

Another further embodiment may further comprise the step of cycling between lists of choices of other possible data values and data symbols associated with the character or beginning of the keystroke sequence if the letter or word choices are too much to display within the predetermined window or display area; selecting the choice and displaying the new choice as text input over the previous text displayed.

A further embodiment could further comprise the step of cycling between the letter or word choice and displaying the next choice as text input over the previous text displayed.

Another embodiment of the method wherein the stored keystroke sequence is only for a predetermined range of number of characters. Also, the number of associated word choices of the matching could have a predetermined maximum number.

A yet further embodiment of the method wherein the order of the associated letter choices of the matching having an order of the most recently selected data to the least recently selected data. Also, the order of the associated word choices of the matching having an order of the most recently selected data associated with the same beginning keystroke sequence to the least recently selected data associated with the same beginning keystroke sequence.

A further embodiment of the method wherein the associated word choice of the matching has a predetermined minimum character length. In addition all selected or inputted data with the minimum character length will be stored in the database of the matching as the most recently selected data associated with the same beginning keystroke sequence.

Another embodiment of the method wherein a choice of punctuations & symbols will be displayed on pressing a key or a combination of keys and/or a choice of numerals will be displayed on pressing a key or a combination of keys.

The keyboard in the embodiments can be any text input system or virtual text input system. The keyboard can also be part of a reduced keyboard system. Also, the character inputted could be one of the characters in a multi-character key where an embodiment of the method may further comprise the step of matching the keystroke inputted with a stored keystroke in a database, the stored keystroke having associated letter choices stored in the database wherein the associated letter choice is a data value or a data symbol associated with the stored keystroke; matching the beginning of the keystroke sequence with a stored keystroke sequence in a database, the stored keystroke sequence having associated word choices stored in the database wherein the associated word choice is a data value or a data symbol associated with the stored keystroke sequence; displaying the matching letter choices associated with the keystroke; displaying the matching word choices associated with the beginning keystroke sequence; and performing as per a multi-character key input, if the character or multi-character key representing the character is inputted ambiguously.

A further embodiment of the method for a reduced keyboard system may further comprise the step of inputting the beginning characters unambiguously using the keyboard; inputting the following characters ambiguously using the keyboard; matching the keystroke sequence or the beginning of the keystroke sequence with a stored keystroke sequence in a database, the stored keystroke sequence having associated word choices stored in the database wherein the associated word choice is a data value or a data symbol associated with the stored keystroke sequence; displaying as text input the data value or data symbol with the same beginning characters assigned to the keystroke; and displaying the matching word choices with the same beginning characters associated with the keystroke sequence.

Another aspect of the invention provides a letter choice and word choice text input system comprising a keyboard or text input detector; a database for storing letter or word choice wherein the letter or word choice is a data value or data symbol associated with an input keystroke of the keys or an input keystroke sequence of the keys respectively; a display for displaying the letter choices or word choices; and a display for displaying the inputted text.

An embodiment wherein the system incorporates the method of inputting for a text input system using letter and word choice text input method as described above.

Another embodiment wherein the letter or word choices are displayed in a predetermined window or display area. In addition, the predetermined window or display area could be in single or double rows where the double row is to separate letter choices and word choices or inputted text with choices.

A further embodiment wherein the data stored is stored in the order of the most recently selected data to the least recently selected data.

Another embodiment of the system wherein the letter and word choices are presented in fixed numbers or groups of fixed numbers. In addition, short-cuts could be associated with the letter and word choices. Also, an auxiliary key or shift key may be used in concert with other keys to function as short-cuts. Furthermore, the auxiliary key or shift key can be sticky or pressed together with other keys to differentiate between the normal auxiliary or shift function and the short-cut function.

An embodiment of the system can use any text input system or virtual text input system for the keyboard even a reduced keyboard system.

Also an embodiment of the system where in the multi-character key of the reduced keyboard system functions as per a multi-character key input when tapped. The multi-character input could be using any existing reduced keyboard system such as those described in U.S. Pat. Nos. 5,818,437; 5,945,928; 5,953,541; 6,011,554; 6,286,064, 6,307,549, and Singapore Patent Application 200202021-2.

### BRIEF DESCRIPTION OF THE DRAWINGS

These and other features, objects, and advantages of embodiments of the invention will be better understood and readily apparent to one of ordinary skill in the art from the following description, in conjunction with drawings, in which:

FIG. 1 shows how an on-screen keyboard with letter or word choice could look like on a touch screen or screen input surface in accordance with an embodiment of the invention;

FIG. 1a shows how an on-screen letter or word choice could look like using a conventional keyboard and display or touch screen (hybrid system) in accordance with an embodiment of the invention;

FIG. 2 shows how letter choice presenting accented or diacritic versions of the inputted character could look like on a touch screen or screen input surface in accordance with an embodiment of the invention;

FIG. 2a shows how the selection of a letter choice could look like on a touch screen or screen input surface in accordance with an embodiment of the invention;

FIG. 3 shows how word choice could look like on a touch screen or screen input surface in accordance with an embodiment of the invention;

FIG. 3a shows how the selecting the same word choice twice could look like on a touch screen or screen input surface in accordance with an embodiment of the invention;

FIG. 4 shows how letter choice and word choice with a predetermined window or display area of one row could look like on a touch screen or screen input surface in accordance with an embodiment of the invention;

FIG. 5 shows how letter choice and word choice with a predetermined window or display area of two rows could look like on a touch screen or screen input surface in accordance with an embodiment of the invention;

FIG. 6 shows how an on-screen reduced keyboard system with letter or word choice could look like on a touch screen or screen input surface in accordance with an embodiment of the invention;

FIG. 7 shows how a reduced keyboard system is implemented as hard keys on a handheld device with letter or word choice on a touch screen or screen input surface to function as a hybrid text input system in accordance with an embodiment of the invention;

FIG. 8 shows how quick selection using short-cuts can be implemented on the reduced keyboard system on a handheld device in accordance with an embodiment of the invention;

FIG. 9 shows a block diagram highlighting the main components associated with the software program in accordance with an embodiment of the invention; and

FIG. 10 shows a flowchart of the letter and word choice text input method in accordance with an embodiment of the invention.

### DETAILED DESCRIPTION

Throughout this description, the embodiments shown should be considered as examples, rather than as limitations on the present invention.

As mobile devices shrink in size and continues to encompass more text-based computing applications that require text-inputting like emails and word processing, the challenge is to present to the user a text-inputting solution that is not only fast, easy, and intuitive, but also to be able to be used for sustained or extended text-inputting.

Currently, there are two main genres of solutions, the hardware based text-inputting methods like miniature keyboards and the software based text-inputting methods which mainly encompass either pen-based or touch screen solutions like handwriting recognition and virtual keyboards or hands-free solutions like speech recognition. Speech recognition though seemingly a compelling alternative to typing and having gone through much improvement, is still plagued with issues of inaccuracies, long training and learning periods, speed, privacy, and other human factors like its usually more natural to think and type than to talk and think. Because of space constraint and limitations, hardware based solutions like miniaturised keyboards with their tiny buttons and keys are difficult to type and errors happen often from pressing the wrong neighbouring keys. Pen-based solutions are not too much better off with handwriting recognition still being largely inaccurate, slow and requiring long learning practices to train the recognition software. Other pen-based solutions like the virtual keyboard encounters the same pitfalls as their hardware counterparts in that the small area allocated to the virtual keyboard also begets tiny buttons which require a lot of concentration and focus to type on and mistypes are frequent.

There have been various attempts to improve text inputting on mobile devices for the virtual keyboard like incorporating a forward prediction engine for the pen-based tap method. The words suggested by the forward prediction engine are usually generic (frequency and choice of words are compiled from generic references like articles, research, etc.) and sorted by a frequency field. Therefore, besides breaking the flow of normal typing to look at the suggested words, the words suggested are often not suitable or intelligent. Because of its ineffectuality, you only see forward prediction in soft keyboards where it is very difficult and cumbersome to type and not fully integrated in other pen-based methods like handwriting or letter recognition text input methods. Clearly, all these solutions are unable to provide a suitable text-inputting platform for sustained or more intensive text-inputting on mobile devices.

Also, existing text input methods do not provide easy methods to input accented or diacritic characters. This difficulty not only applies to mobile text input solutions but also to conventional keyboards as well, where you require pressing special auxiliary keys to select the accented or diacritic characters.

We have recognised that there is a way to make mobile text-inputting solutions much more effective. That is to have a more efficient word and letter suggestion system, complemented with a powerful choice window that provides a good presentation of the choices as well as easy selection. This powerful choice system is extremely versatile and can be used on screen input systems or complemented with hard keyboards to form a unique hybrid keyboard system (hard keys with a screen input choice window) or with reduced keyboard systems to also help in presenting word choices formed from ambiguous multi-character key inputting.

In fact, the letter and word choice system can be used to enhance any text input system, be it glove input system, voice recognition system, or hand writing recognition system. The method is applicable to all manners of keyboard including QWERTY-type keyboards like the English, French and German keyboards and also non-QWERTY-type keyboards like the Fitaly (Textware™ Solutions Inc.—U.S. Pat. No. 5,487,616), Opti I, Opti II, Metropolis keyboard, and even Chinese keyboards, Japanese keyboards, etc.

The idea and purpose of the invention is to have an input system that enhances existing text entry methods as well as new text entry methods. By providing letter choices for unambiguous character input, we are able to provide appropriate accented, diacritic or special characters that can be attributed to the character inputted as choices. Thus, a user simply needs to select the letter choice to input the special characters. This makes it much simpler to input accented and diacritic characters using just the same keys for the normal characters, negating the use of extra keys to represent the special characters or auxiliary keys to work in tandem with the character keys to input accented or diacritic characters.

In our invention, we are able to very aptly suggest word possibilities that a user is intending to type after an initial keystroke sequence (beginning keystroke sequence). This word choice is able to very quickly personalise not only to words that a user likes to use but to words that are relevant to the context/content of text that is being written. Words that are irrelevant or not used by the user are also very quickly pushed out of the list of word choices. This method is also used to efficiently present word choices that are possible words ambiguously typed from a keystroke sequence using an ambiguous reduced keyboard system with multi-character keys. Word suggestion as well as ambiguous word choices can be presented together for reduced keyboard systems to further enhance them.

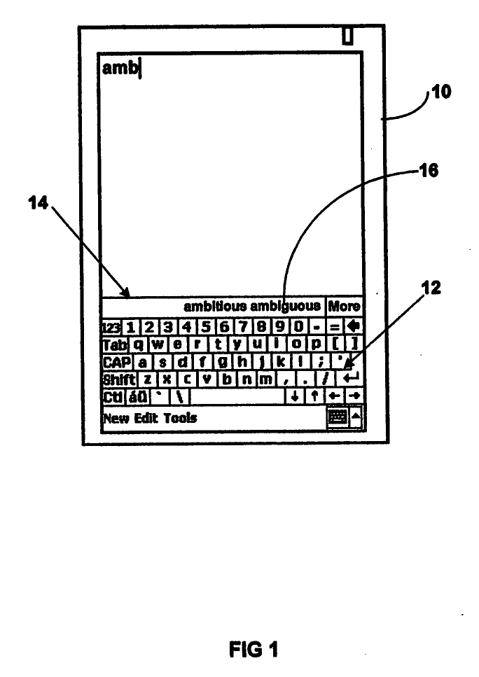

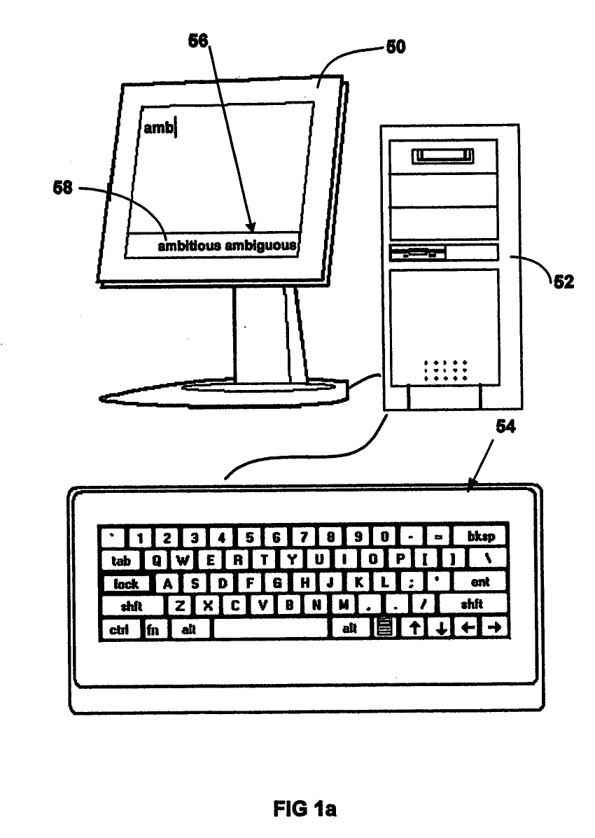

An application for the invention would be for small, medium devices like mobile devices, PDAs, handhelds, Pocket PCs, mobile phones, tablet PCs or even virtual keyboards or any devices that uses screen-based or pen-based inputting. FIG. 1 shows how an on-screen implementation of a choice window 14 with word choices 16 could look like on a handheld device 10 with a virtual keyboard 12. FIG. 1a shows how an on-screen implementation of a choice window 56 could look like with word choices 58 on a display 50, that can be either a normal display or touch screen display. The display 50 is used in conjunction with a normal keyboard 54. The keyboard 54 is usually linked to a computing processor 52 and the display 50, to which the text inputting appears, is on a separate screen 50 which is linked to the same computing processor 52.

The embodiments depicted in the drawings, and the system discussed herewith may generally be implemented in and/or on computer architecture that is well known in the art. The functionality of the embodiments of the invention described may be implemented in either hardware or software. In the software sense, components of the system may be a process, program or portion thereof, that usually performs a particular function or related functions. In the hardware sense, a component is a functional hardware unit designed for use with other components. For example, a component may be implemented using discrete electrical components, or may form a portion of an entire electronic circuit such as an Application Specific Integrated Circuit (ASIC). There are numerous other possibilities that exist, and those skilled in the art would be able to appreciate that the system may also be implemented as a combination of hardware and software components.

Personal computers or computing devices are examples of computer architectures that embodiments may be implemented in or on. Such computer architectures comprise components and/or modules such as central processing units (CPU) with microprocessor, random access memory (RAM), read only memory (ROM) for temporary and permanent, respectively, storage of information, and mass storage device such as hard drive, memory stick, diskette, or CD ROM and the like. Such computer architectures further contain a bus to interconnect the components and control information and communication between the components. Additionally, user input and output interfaces are usually provided, such as a keyboard, mouse, microphone and the like for user input, and display, printer, speakers and the like for output. Generally, each of the input/output interfaces is connected to the bus by the controller and implemented with controller software. Of course, it will be apparent that any number of input/output devices may be implemented in such systems. The computer system is typically controlled and managed by operating system software resident on the CPU. There are a number of operating systems that are commonly available and well known. Thus, embodiments of the present invention may be implemented in and/or on such computer architectures.

The letter and word choice input method can be implemented either by software, hardware or a hybrid of both. Generally, if its implemented purely via software, for example with a softkey (e.g. virtual keyboards on a touch screen) implementation, the device that the letter and word choice input text inputting method is implemented on typically has an Operating System, a BIOS (Basic Input/Output System), a display and an input mechanism (e.g. touch screen and stylus). Then the software for the letter and word choice input text inputting method may include a software program (that covers the methodology) written in a programming language supported by the operating system and a populated database, that covers the assignment of data values and data symbols with detection regions.

If the letter and word choice input text input method is implemented with a keyboard system in hardware, for example as a hardkey accessory, then the hardware may encompass a processor, a memory module like ROM/EPROM, an input mechanism such as buttons, keys, sensors and the like, and an interface socket to the device such as mobile devices, PDA, handheld computers, mobile phones, console devices and the like. Of course, the display could either be configured on the reduced keyboard system hardware or on the device. Various combinations are possible. The program and database could be stored in the memory modules and the processor a generic microprocessor that runs the program in the memory and relays the information to the display and interface socket. The program could also be mapped to the processor for example as in a digital signal processor (DSP) and the database stored in the memory module. Generally, the processor is the main central unit. On inputting on the input mechanism, a signal is sent to the processor. The processor may either process the signal for example if the program is stored in the processor or it will query the memory and process the information in the memory with regards to the signal from the input/output device. The processor of the hardware solution of the reduced keyboard system will then output signals to the display and/or via the interface socket to the device for example PDA, hardware accessory, and the like.

As a hybrid solution, the memory in the implemented device, for example a PDA or the like, could be used to store the program and database via a software or software driver and using the device's processor to process the program as similar to the first case discussed above. The hardware may include an input mechanism such as buttons, keys, sensors and an interface. If the input mechanism is built onto the device for example with additional buttons, then the interface may simply be wires or wireless means that connect and communicate to the device. If the input mechanism is on an external device, such as an accessory, then the interface may be like an interface socket like in the second case discussed above, and the display may be implanted on the hardware solution like in the earlier case with the accessory or using the display of the device.

Of course, to implement the keyboard system in hardware, there may be connecting wires like circuit boards to house the circuitry, processors, memory, etc, and a housing that mounts the entire hardware part like buttons, display and the circuit board.

Letter Choice

There have already existed text input methods that offer letter choices, but they have only been used to offer letter choices to resolve the ambiguity of multi-character keys when tapped (i.e. display all the choices of characters associated as a set of the multi-character key). Our invention treats the choice method (letter and word choice) as a text input method of its own, which is very versatile, powerful and can be easily integrated and applied to all text inputting systems to enhance text entry. In the case of letter choice, this is particularly true for inputting accented or diacritic characters.

Because usually to input accented or diacritic characters, you would require extra keys or an auxiliary key to work in concert with normal character keys, it is not easy to input accented or diacritic characters, especially on screen input devices like handhelds or mobile devices as the screen is usually smaller and it is harder to do duo key input (i.e. 2 keys pressed in concert) as screen input is usually entered using a single stylus input.

What is required is a method whereby a user can key using a normal keyboard configuration yet being easy to enter accented or diacritic characters. This comes in the form of letter choices. When you enter a normal character, if there are possible accented, diacritic or special characters that can be associated with the character, they will be presented as possible letter choices.

E.g. 1 When entering the normal character “e”, the following letter choices can be shown:
é è ê ë

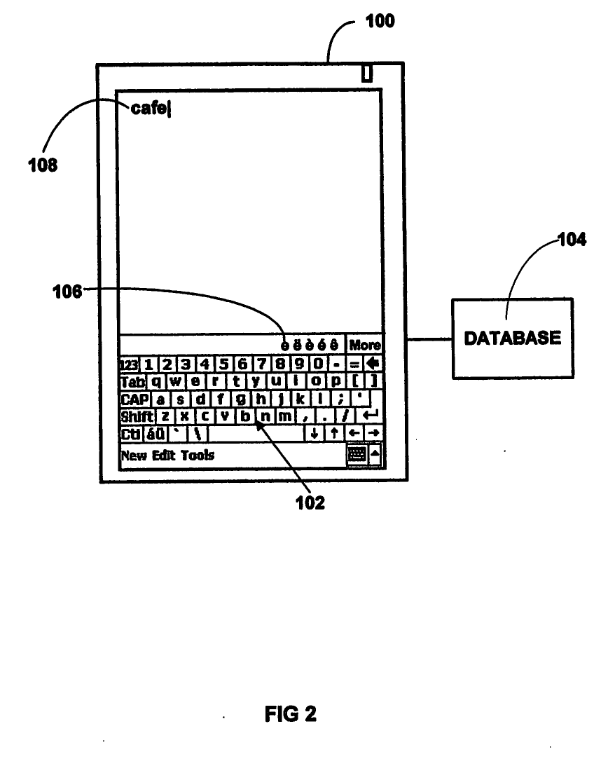

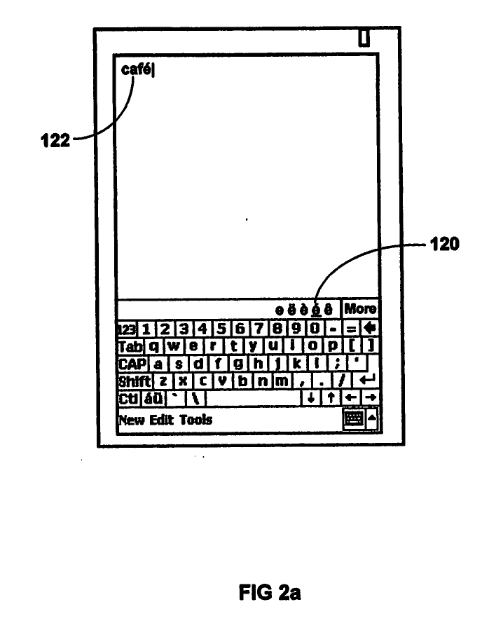

Thus, to input a special character, the user simply needs to select the appropriate letter choice. Therefore, to type the word café, a user just need to type “c”, “a”, “f”, “e” and then selecting “é from the letter choice, thus, completing the word “café”. FIG. 2 shows how letter choice 106 presenting accented or diacritic versions of the inputted character could look like on a touch screen or screen input surface of a handheld device 100 that consist of a virtual keyboard 102 and a database 104. By selecting the letter choice “é” 120 in FIG. 2a, the word “cafe” 108 in FIG. 2 is changed to the word “café” 122 in FIG. 2a.

Thus, the letter choice will be shown based on the associated accented, diacritic, or special characters tied to the character inputted in a letter choice library.

Letter Choice Library

A letter choice library database is use for the letter choice text entry method. Basically, every character unambiguously inputted will search for a match in the letter choice letter library to see if a set of letter choice need to be shown for the character inputted. Example of a letter choice library is as shown (where “|” is used to indicate a delimiter between data):

| Character | Associated Special Characters |
|---|---|
| a | ä \| à \| á \| â \| ã \| å \| æ |
| c | ç |
| d | [symbol] |
| e | ë \| è \| é \| ê |
| i | ì \| í \| î \| ï |
| n | ñ |
| o | ö \| ò \| ó \| ô \| õ \| ø \| œ |
| s | β \| \check{s} |
| t | [symbol] |
| u | ü \| ù \| ú \| û |
| y | ý \| ÿ |

To allow continuity, the letter choice can contain the character itself besides the associated special characters (e.g. letter choice for “c” would be “c” and “ç”). Thus, for editing (e.g. when backspacing to a character with letter choice), a user will be able to select the normal character as an option.

Word Choice

Although there are some word suggestion systems already existing like WordLogic and Microsoft® virtual keyboard, they are usually based on frequency and are usually only used for screen input keyboards where tiny keys necessitates a forward predict word suggestion system to aid in text entry. Our invention serves to make word choice much more useful and powerful as it can personalise to a users preference instantaneously and also to the current content/context that is being typed. It does this by using a most recently used method instead of a most frequently used or most commonly used method adopted by other word suggestion engines. The power of the word choice method is that by ordering the possible word choice in the order from the most recently used to the not so recently used, the invention is able to achieve two main things. One is that obscure words that are use in the current context of the conversation/passage are able to be presented to the top of the list instantly. The second is that frequently used words that are not used in the current context of the conversation/passage are quickly moved down the list.

Our invention also differs in that our method is tied to keystroke sequence thus, enabling it to be used for reduced keyboard systems as well as conventional keyboards. Another difference is that in our word choice method, a minimum number can be set for the number of characters a word must contain before being allowed to be saved into the word library. A minimum number can also be set for the number of characters of the beginning keystroke sequence before the word choice is shown or any word choice is tied to the beginning keystroke sequence. This minimum number for the number of characters of the beginning keystroke sequence can be in the form of a range of numbers. The number of words associated with the beginning keystroke sequence can also be fixed so as to always maintain a relative fix size for the word choice library.

Word Choice Library

The key to the word choice method is the word choice library database and how word choices are stored for keystroke sequences. Three numbers are used to set the profile of the word choice library database to provide efficiency and enhance the power of the word choice method. Firstly, a minimum number (e.g. x) is set for the number of characters of the beginning keystroke sequence before the word choice is shown or any word choice is tied to the beginning keystroke sequence. This minimum number for the number of characters of the beginning keystroke sequence can be in the form of a range of numbers. Next a minimum number (e.g. y) is set for the number of characters a word must contain before it can be saved into the word library. This number helps to set a minimum number of strokes (e.g. characters) the word choice will save the user from typing if he were to select the word from the word choice rather than typing out the full word. Thirdly, the number of words (e.g. z) to be stored for each beginning keystroke sequence can be fixed, thus all new words after this maximum number is reached will push out the least recently used word sharing the same beginning keystroke sequence. The fixed number of words stored per beginning keystroke sequence is thus sorted from the most recently used word to the least recently used word that share the same keystroke sequence.

E.g. 2 Let x be a range from 3 to 4, y=7 for x=3 and y=8 for x=4 (i.e. the word choice must save the user a minimum of 4 strokes before being recorded or stored in the word choice library database for that beginning keystroke sequence that range from 3 to 4 character combinations). Let z=3 meaning that per beginning keystroke sequence, a maximum of 3 words will be stored and presented as word choice per beginning keystroke sequence. The word choice library database could look something like (where “|” is used to indicate a delimiter between data and the underlined characters is just to show that they share the same starting keystroke sequence):

| Beginning Keystroke Sequence | Associated Word Choices |
|---|---|
| aba | abandon \| abandoned \| abashed |
| abd | abdicate \| abdomen |
| abe | aberrant \| abeyance \| aberration |
| . . . | . . . |
| dev | developer \| devastating |
| . . . | . . . |
| deva | devastating \| devastate \| devalue |
| deve | developer \| developed \| develop |
| . . . | . . . |

When entering the keystroke sequence “d”, “e”, “v” using a conventional keyboard (e.g. not a reduced keyboard system), the following word choices will be shown:

developer|devastating

If the user selects any of the word choices, the choice will replace the text that was inputted previously (in this case adev”). If the user continues to type the letter “a”, the following word choices will be shown:

dvastating|devastate|devalue

The user can again select any of the above word choices to replace the text that was inputted previously (in this case “deva”). If none of the words are what the user wants and the user continues to type the word “devastation”, then this word will now be stored as the first choice (most recently selected word choice) for both the beginning keystroke sequences of “dev” and “deva”, pushing out any other word choice if the total number of word choices for the beginning keystroke sequence exceeds 3. The word choice storage for these two beginning keystroke sequences will then look like (where “|” is used to indicate a delimiter between data and the underlined characters is just to show that they share the same starting keystroke sequence):

| Beginning Keystroke Sequence | Associated Word Choices |
|---|---|
| dev | devastation \| developer \| devastating |
| . . . | . . . |
| deva | devastation \| devastating \| devastate |

Consequently, if the user enters and finishes the word “devas” (e.g. the word “devas” is selected by space, punctuation or carriage return), it would not be stored in the database as it does not have sufficient character length.

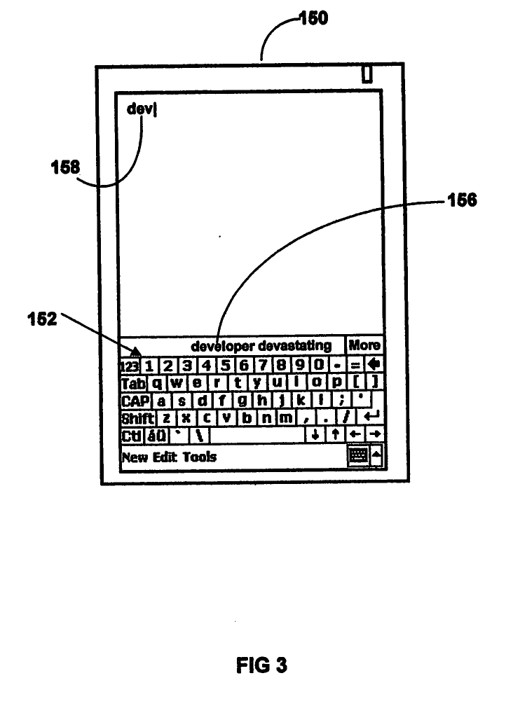

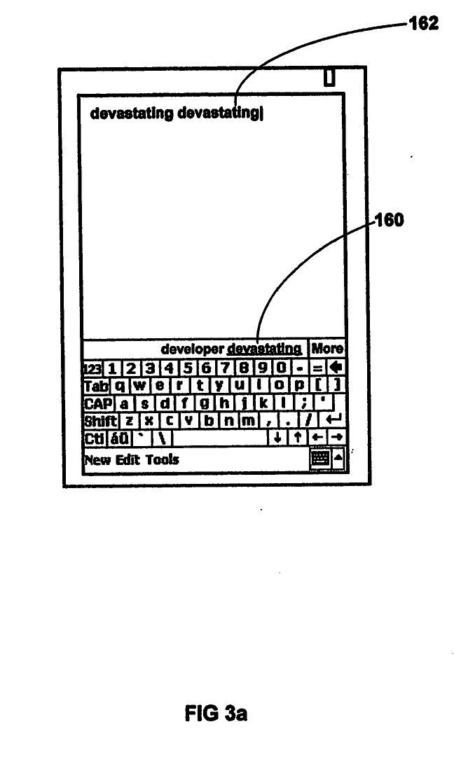

FIG. 3 shows how word choice 156 presenting word possibilities of the beginning keystroke sequence 158 could look like on a touch screen or screen input surface of a handheld device 150 that consist of a virtual keyboard 152.

The power of ordering the word choices from the most recently used word to the least recently used word is that there is no need to have an additional field for every word to keep track of frequency or to preorder the words to contain only commonly used words, like other methods. In fact, building the word choice library database can start from a clean slate and only start recording words for the beginning keystroke sequences as words are typed, selected (e.g. separated by a space, punctuation or enter key) and are eligible (i.e. satisfy the 3 variables x, y and z).

The word choices can also include accented, diacritic or special characters as well making this a very simple and powerful method of entering accented words as in European languages. The power of letter and word choices is further enhanced with innovative selection methods as well as efficient presentation of the choices.

Choice Selection

There are several mechanisms in our invention to make choice method more effective by enhancing the efficiency of choice selection. When a user keys in text as per normal, the text will appear on the display together with any choice that is appropriate (e.g. letter choice, word choice or both). By selecting the choice, either the letter last inputted is replaced by the choice (i.e. if a letter choice was selected) or the entire text inputted is replaced by the choice (i.e. if a word choice was selected) (selection). If after selection, a different choice is selected (e.g. a wrong selection was made), the new choice will replace the previous choice (correction). If the same choice is selected again, then the choice will be displayed again as new text (duplication) as shown in FIG. 3a where selecting the word choice “devastating” 160 for a second time inputs the same word 162 twice in the display.

These simple rules help incorporate the basic mechanisms of selection, correction and duplication. To further enhance selection and incorporate advance mechanisms, a predetermined window or display area is used to more efficiently present the letter and word choices.

Choice Presentation (Window)

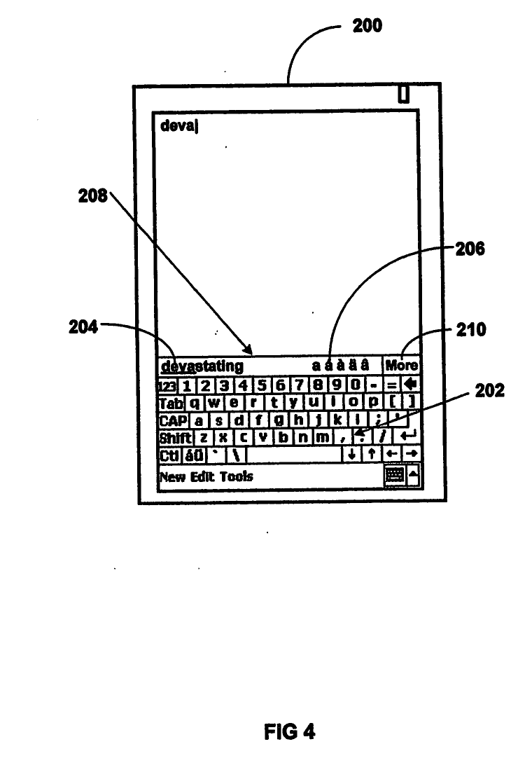

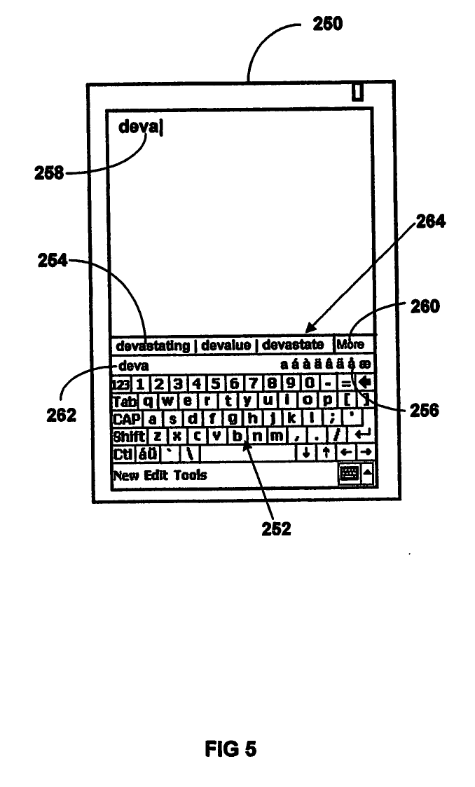

In order to enhance choice selection and choice presentation, a predetermined window or display area is used to display the choices. Our preferred embodiment for the predetermined window or display area is either in one or two rows as this minimises the amount of space needed to display the choices. FIG. 4 shows how letter choice 206 and word choice 204 with a predetermined window or display area of one row 208 could look like on a touch screen or screen input surface of a handheld device 200 that consist of a virtual keyboard 202. Scroll button 210 enables user to see more choices if they are not all able to fit into the one row. FIG. 5 shows how letter choice 256 and word choice 254 with a predetermined window or display area of two rows could look like on a touch screen or screen input surface of a handheld device 250 that consist of a virtual keyboard 252. Scroll button 260 enables user to see more choices if they are not all able to fit into the one row while the current text inputted 262 is shown in the predetermined window as well so as to minimise the amount of look-up 258 a user needs to do to monitor/track his text entry.

These simple basic elements of the choice window to efficiently present letter and word choice and the current inputted text, occupies little space and yet can be applied to virtually all text input systems and devices. By offering the current inputted text to be displayed near the input keys and choices allows the user to concentrate on only one part of the screen (one focus of attention) to input text thus making text entry easier and more efficient. Also, the scroll button allows for more choices to be displayed that can normally be fitted into the limited space of the choice window.

Besides the above advantages, our choice window also allows for more advanced mechanisms of choice selection.

Advanced Choice Selection

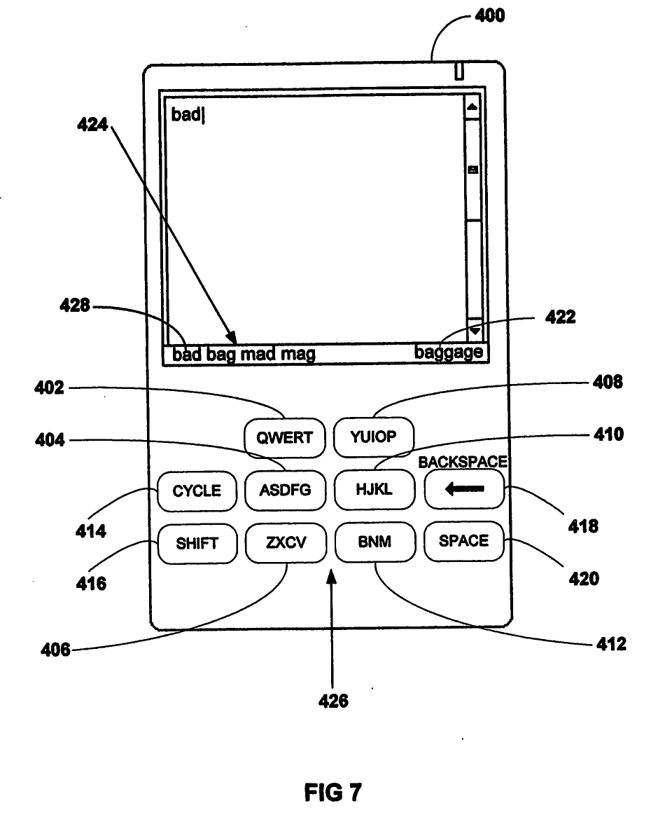

One of the easiest and most powerful selection tools is the use of a screen input interface for choice selection. This allows direct selection of the choice. Using a screen input interface for selection is not new and has been used in solutions like WordLogic and Microsoft® virtual keyboard. Selection on a screen input interface is used by default because the virtual keyboard itself is on a screen input interface. In our invention, we can use the screen input interface for choice selection even for keyboards or input systems that do not reside on the screen input interface. This we term as a hybrid text input system as shown in FIG. 1a where a conventional keyboard 54 is used in concert with a screen input interface 50 for choice selection and also in FIG. 7 with hard-keys 426 and screen input choices 422 and 424.

With a predetermined window, we are able to select the word choices even without a screen input interface. This is done with the help of short-cut keys or a cycle key. For short-cut keys, the short-cut key is displayed beside the choices in the predetermined window. To select the choice is simply a matter of keying in the short-cut key assigned to the choice. The shirt-cut key can be any key or combination of keys.

A cycle key can work in two ways. It can either cycle list of choices if the choices are not all able to fit into the predetermined window. The cycle key in this case work similar to the scroll button 210 and 260 in FIG. 4 and FIG. 5 respectively. In this case the cycle key is a scroll cycle key. The second way a cycle key can be used is to select the choice. Pressing on the cycle key chooses the first choice while pressing it again cycles to the next choice and the next until it loops back to the first choice. In this case, the cycle key acts as a selection cycle key and the mechanism is similar to correction where the next choice superposes on the previous choice. Any key or combination of keys can be assigned to the cycle key. Variants to the cycle key includes different cycle keys for letter and word choices or a cycle key for backwards selection (going in a reverse direction to the selection cycle key) called a reverse selection cycle key.

One of the powerful abilities of our design is that it can work very well in reduced keyboard systems, in fact, enhancing them to become even more effective and easy to use.

Choice Method with Reduced Keyboard Systems

The choice method will work with any reduced keyboard system but we have selected to use the reduced keyboard system as described in the TenGO™ reduced keyboard system, Singapore Patent Application 200202021-2.

The reduced keyboard uses six multi-character keys to represent the keyboard layout.

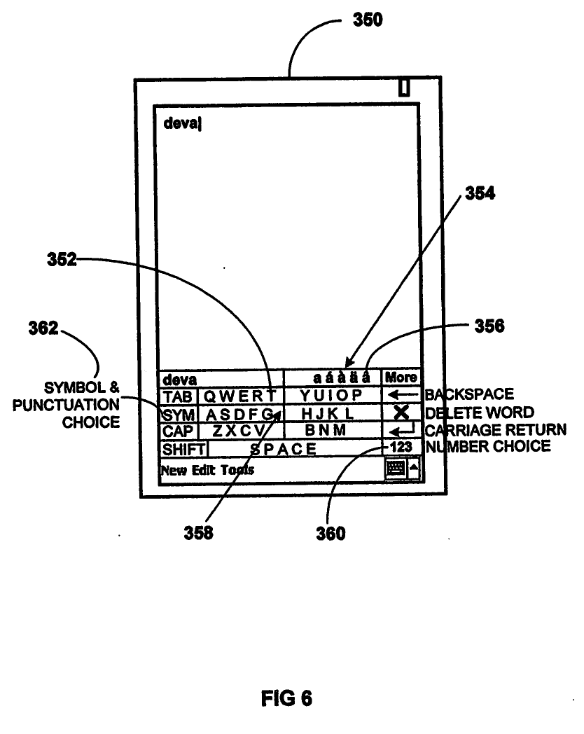

FIG. 6 shows how the multi-character keys 352 of the TenGO™ reduced keyboard 358 with letter choice 356 shown in a predetermined window 354 could look like on a touch screen or screen input interface of a handheld device 350.

Every reduced keyboard system will have its own method of unambiguous text entry to enter text that is not present in the disambiguating word library or to enter individual characters. Examples of the more conventional unambiguous text input methods of multi-tap, two-keystroke or multiple-stroke interpretation, and scribing are described in U.S. Pat. Nos. 6,011,554 and 6,307,549 and Singapore patent application 200300895-0 for reduced keyboard systems. When a character is unambiguously entered using such methods for a reduced keyboard system, the letter choice method can be used to provide letter choices of accented, diacritic or special variants of the inputted character. This makes keying-in of accented characters much simpler for reduced keyboard systems.

By using keystroke sequence as an index for the word choice library, we are also able to use the word choice method effectively for reduced keyboard systems as well.

Note: These choices are word look-ahead choices that are displayed in addition to the word choices that normally accompany reduced keyboard systems because of the ambiguous nature of multi-character input.

The word choice library database for a reduced keyboard system could look something like (where “|” is used to indicate a delimiter between data):

| Beginning Keystroke Sequence | Associated Word Choices |
|---|---|
| Key1, Key1, Key1 | abandon \| backlash \| cabinet |
| Key1, Key1, Key2 | baggage \| achieve |
| Key1, Key1, Key3 | acknowledge \| calligraphy \| campaign |
| . . . | . . . |
| Key1, Key1, Key1, Key1 | bacchanalian \| cabbages |
| Key1, Key1, Key1, Key2 | badgered \| bachelor |
| . . . | . . . |

Therefore, when inputting words ambiguously using the multi-character keys, the word choice will show both the word choices for the ambiguous input as well as suggested word possibilities. Thus if a user enters the keystroke sequence Key1, Key 1, Key1, he will get the disambiguating word choices like “bad”, “cab”, “cad” as well as the word possibilities “abandon”, “backlash”, and “cabinet”.

All the previous selection methods can be applied to reduced keyboard system with one caveat, since it is a reduced keyboard system there is a limited number of keys that could be used for selection. Thus, one of the ideal platforms for choice presentation and selection would be the screen input interface (e.g. touch screen). This enables direct selection of the choices from the screen and does not necessitate much additional keys, besides a scroll cycle key. This is especially powerful even for reduced hard keyboard systems by incorporating a hybrid reduced keyboard system (i.e. hard-keys for text entry and screen input for choice selection). FIG. 7 shows how a reduced keyboard system 426 with multi-character keys 402, 404, 406, 408, 410, 412 can be implemented with just 4 other auxiliary keys, SHIFT 416, Cycle (for scroll cycle key) 414, Backspace 418 and Space 420 on a touch screen or screen input surface of a handheld device 400 with a predetermined choice window 424 and word choices for word suggestion 422 and word choices for disambiguating the multi-character key input 428 to function as a hybrid text input system.

For non-screen input interfaces, we have developed an efficient choice selection system for reduced keyboard systems that uses a minimum of keys for quick selection of choice. This is done using the SHIFT key, preferably a SHIFT key that have a differentiated sticky and non-sticky SHIFT (sticky is where you just press the SHIFT key once and the SHIFT mode is registered, followed by pressing another key and non-sticky is where you continuously hold down the SHIFT key while pressing another key). This allows for the SHIFT key to function as a normal SHIFT key when used in the non-sticky mode while allowing the sticky SHIFT mode to trigger the quick select or vice versa.

Quick select is done by first pegging short-cut keys to the choices. Because there are six multi-character keys, it is reasonable to set a maximum limit of six choices per predetermined window display. If the number of choices exceeds six, then the scroll cycle key is used to scroll to the next set of six choices and so forth. The short-cut key beside each choice could be a number from 1 to 6. To auick select choice number 1, a user simply needs to sticky SHIFT then press Key1 to select it, likewise to quick select choice number 2 is sticky SHIFT and then pressing Key2. This method is very simple and it uses the same SHIFT key thus minimising the need for an extra auxiliary key. Of course, if space allows for an extra key, then an auxiliary key can be used in place of the sticky SHIFT. To perform a normal SHIFT function (i.e. capitalise one of the letters) simply press and hold the shift key (non-sticky SHIFT) while pressing the multi-character key representing the letter. Of course, the functions of sticky SHIFT and non-sticky SHIFT can be reversed. This quick select mechanism can be used to quick select letter choices when unambiguously inputting letters or to quick select word choices when tapping ambiguously on the multi-character keys. The quick select method is powerful enough to be used for all manners of choice selection and fast yet using a minimal number of keys.

Another method that can be used to select the choices is the selection cycle method by using the cycle key as a selection cycle key, whereby pressing on the selection cycle key selects the next choice in order. This method can again be applied to both letter and word choices depending on the mode of input (character or word input).

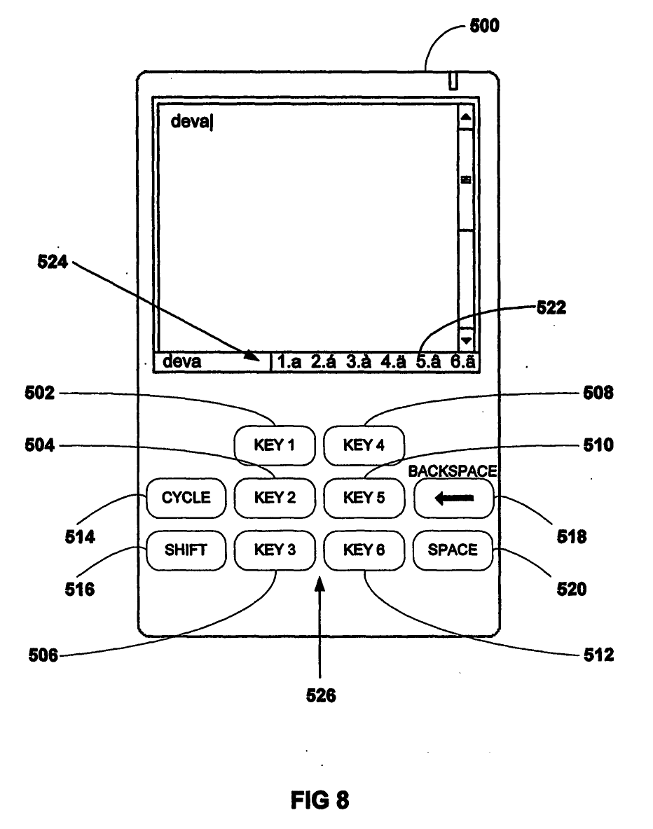

For letter choice selection during letter inputting (e.g. letter inputting mode for reduced keyboard system), when the user presses the multi-character key, the user will be able to select the letter he wants through any of the conventional disambiguating methods. After which the user will be presented any accented or diacritic characters associated with the selected character which can again be quick selected via the short-cut key placed beside the choice in the predetermined window. FIG. 8 shows how an alphabetical reduced keyboard system 526 with multi-character keys 502, 504, 506, 508, 510, 512 can be implemented with just 4 other auxiliary keys, SHIFT (sticky and non-sticky function) 516, Cycle (for scroll cycle key or selection cycle key) 514, Backspace 518 and Space 520 on a handheld device 500 with a predetermined choice window 524 and choices with associated short-cuts 522 to function as a reduced text input system with quick selection. By quick selecting choice number 3 (sticky shift and then pressing Key3 506), will change the text inputted from “deva” to “deva”.

Another mechanism that can be incorporated to assist reduced keyboard system is front character locking. This is done by inputting the beginning of the word unambiguously, letter by letter and then switching back to ambiguous text inputting to finish the word. In this case, only word choices matching the beginning of the word (the letters typed unambiguously) are shown. This will help users key-in particularly long words or minimise word choices when there are a lot of ambiguity in the keystroke sequence of the multi-character keys. This could also mean more suggested word choices could be stored and then filtered by locking the first few characters.

To complete the reduced keyboard system with the choice method would be to allow for input of numerals and punctuations and symbols. This is also done using the choice method. If additional keys are possible (e.g. soft keyboard on a screen input surface), then 2 additional keys can be included as shown in FIG. 6. One key, the numeral choice key 360, when pressed will show numeral choices on the predetermined window and another key, the symbols and punctuation key 362, when pressed will show punctuation and symbol choices on the predetermined window. Selecting and cycling through the list of choices is as discussed above, either via direct selection (for screen input surface) or quick select and cycle keys.

Our preferred embodiment is for a reduced keyboard system with our letter and choice text input system as it truly enables text inputting to be more practical and efficient on mobile devices and applications. The reduced keyboard system will occupy a minimum amount of space while the letter and word choice system will make it more efficient for choice suggestion, presentation as well as selection.

Letter and Word Choice Text Input System

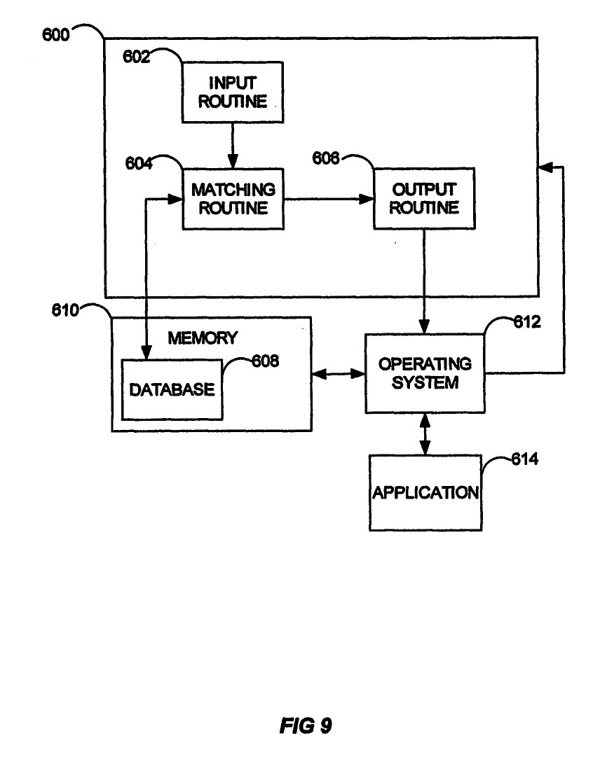

The letter and word choice text inputting method can be implemented on any text input or virtual text input systems like pen-based systems and devices as a software program or device driver. FIG. 9 shows the main components associated with a software program for letter and word choice text inputting system, in accordance with this invention. The letter and word choice text input system 600 would mainly comprise of a display 606 with text input device 602, a database 608 to store set of data values and data symbols assigned to the various characters, and beginning keystroke sequence which is representative of the displayed characters on the text input device and also any special characters or functions associated with the characters, a software program 600 or device driver 600 with an input routine 602, matching routine 604 as well as an output routine 606. The database usually resides in the memory 610 and every application 614 (e.g. emails, word processing, spreadsheets), even the software program 600 or device driver 600 and memory, would function under the control of an operating system 612 such as Windows CE, WinXP or Palm OS.

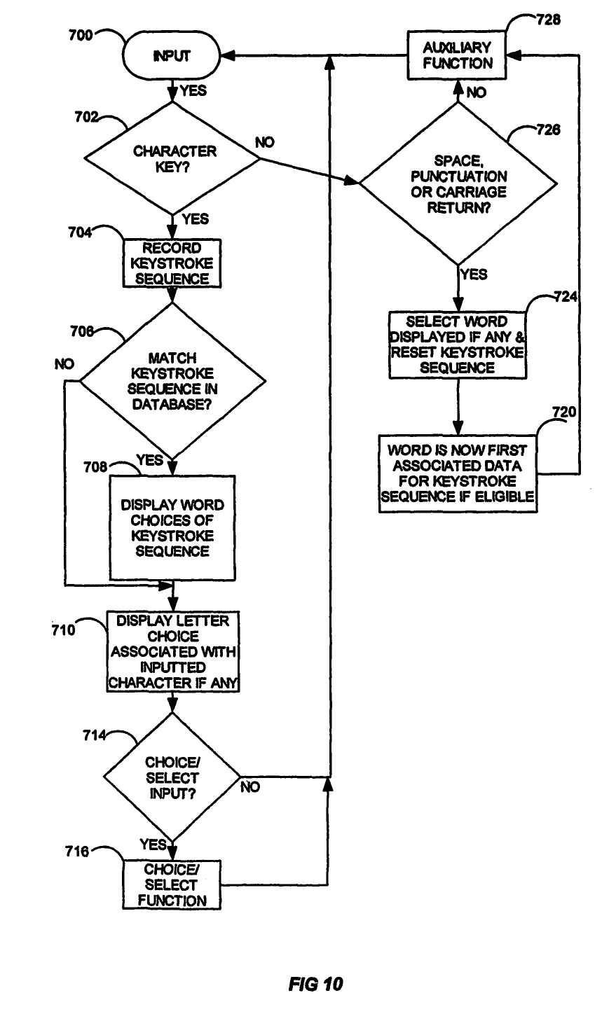

FIG. 10 shows the concept of the letter and word choice text input method. A user need only press the input key 700. If that input key is a character key 702, the database engine will display any word choices that are indexed to the beginning keystroke sequence 704, from a built word choice library database 706. The database will also display the letter choice associated with the character key inputted 710. If the word choice or the letter choice is what the user wants, the user simply selects it using any of the selection methods described above 714 and the letter choice or word choice will be displayed accordingly as text inputted 716. If the key inputted is not a character key and is a space, punctuation or carriage return 726, then the selected word choice 724 if any (either a word choice was previously selected or a word text was inputted that fits into the criteria of being stored in the word choice library database) will now be the first choice associated with the beginning keystroke sequence 720 and the keystroke sequence will reset 724. The non-character key (e.g. auxiliary key) will perform its auxiliary function as per normal 728.

Some design factors taken into consideration for the letter choice and word choice input text inputting methodology and implementation was the frustration when tapping on small soft-keys on screen for small mobile devices like handhelds, PDAs, mobile phones, pocket PCs and tablet PCs. The requirements were for better and more efficient ways to input text (choice method for easier input of accented characters as well as better word suggestion choices) without compromising display screen size (i.e. alphabetical reduced keyboard system as a hybrid text input solution), fast adoption and a low learning curve, and be compatible with all manners of text input systems, which includes QWERTY-type keyboards like the English, French and German keyboards and also non-QWERTY-type keyboards like the Fitaly (Textware™ Solutions Inc.—U.S. Pat. No. 5,487,616), Opti I, Opti II, Metropolis keyboard, and even virtual keyboards and non-keyboard text input systems, etc. The methodology developed was also to be implementable on reduced keyboard systems which use multi-character keys so as to provide quick and seamless ways to select text, with or without screen input interface and using the minimum of keys to accomplish this.

In view of the above description, the essence of an embodiment of the present invention is to provide an enhancement to existing text input systems especially for text entry on mobile devices. Although the references are for characters, the teachings of the present system could easily be extended to any symbol, numeral, or function. Numerous embodiments of the teachings of the present invention beyond those specifically described here are possible and which do not extend beyond the scope of those teachings, which scope is defined by the appended claims. In particular, applications of the system are not limited to the standard unambiguous code or to applications only in mobile devices or conventional devices requiring text input, but are well suited for other applications and embodiments, even “futuristic” (less conventional) ones like writing surface pads, sensor pens and optical or movement recognition input devices, or any electronic device requiring a means to input a string of non-random characters.

Additionally, not all the methodology and mechanisms need be implemented to complete the text input systems as long as its essence remains and main text input functions are intact, thus allowing for the omission of certain methodologies and mechanisms to reduce cost, software size, implementation requirements and/or even some good-to-have (but not critical) functionalities.

It will be appreciated that, although specific embodiments of the invention have been described herein for purposes of illustration, various modifications may be made without departing from the scope of the invention. Accordingly, the invention is not limited except by the appended claims.

What is claimed is:

1. A method of inputting for a text input system, wherein to input a data value or data symbol on a keyboard using a letter and word choice text input method comprising the steps of:
inputting a character using the keyboard;
matching the unambiguous character inputted with a stored keystroke in a database, the stored keystroke having associated letter choices stored in the database wherein the associated letter choice is a data value or a data symbol associated with the stored keystroke;
matching the beginning of the keystroke sequence with a stored keystroke sequence in a database, the stored keystroke sequence having associated word choices stored in the database wherein the associated word choice is a data value or a data symbol associated with the stored keystroke sequence;
displaying as text input the data value or data symbol assigned to the inputted character or keystroke sequence;
displaying the matching letter choices associated with the character; and
displaying the matching word choices associated with the beginning keystroke sequence.

2. A method of inputting as claimed in claim 1 wherein the letter choice are accented or diacritic variations of the associated character.

3. A method of inputting of claim 1 further comprising the step:
selecting a new choice; and
displaying the new choice as text input over the previous displayed text.

4. A method of inputting of claim 3 further comprising the step:
displaying as text input again the data value or data symbol if the same choice is selected again.

5. A method of inputting of claim 1 wherein the choices are displayed in a predetermined window or display area.

6. A method of inputting of claim 5 wherein the predetermined window or display area is on a screen input system and the choices can be selected directly from the screen.

7. A method of inputting of claim 5 wherein short-cut keys are associated or displayed beside the choices.

8. A method of inputting of claim 7 further comprising the step:
pressing the short-cut key; and
displaying the choice associated with the short-cut key as text input over the previous displayed text.

9. A method of inputting of claim 5 further comprising the step:
cycling between lists of choices of other possible data values and data symbols associated with the character or beginning of the keystroke sequence if the letter or word choices are too much to display within the predetermined window or display area;
selecting the choice; and
displaying the new choice as text input over the previous displayed text.

10. A method of inputting of claim 5 further comprising the step:
cycling between the letter or word choice; and
displaying the next choice as text input over the previous displayed text.

11. A method of inputting of claim 1 wherein the order of the associated letter choices of the matching having an order of the most recently selected data to the least recently selected data.

12. A method of inputting of claim 1 wherein the stored keystroke sequence is only for a predetermined range of number of characters.

13. A method of inputting of claim 1 wherein the number of associated word choices of the matching has a predetermined maximum number.

14. A method of inputting of claim 1 wherein the order of the associated word choices of the matching having an order of the most recently selected data associated with the same beginning keystroke sequence to the least recently selected data associated with the same beginning keystroke sequence.

15. A method of inputting of claim 1 wherein the associated word choice of the matching has a predetermined minimum character length.

16. A method of inputting of claim 15 wherein all selected or inputted data with the minimum character length will be stored in the database of the matching as the most recently selected data associated with the same beginning keystroke sequence.

17. A method of inputting of claim 1 wherein the word choice can contain accented and diacritic characters but the stored keystroke sequence only contains the corresponding normal characters or unaccented representation.

18. A method of inputting of claim 1 wherein the keyboard can be any text input system or virtual text input system.

19. A method of inputting of claim 18 wherein the keyboard is part of a reduced keyboard system.

20. A method of inputting of in claim 19 wherein the character could be one of the characters in a multi-character key.

21. A method of inputting of claim 20 further comprising the step:
matching the keystroke inputted with a stored keystroke in a database, the stored keystroke having associated letter choices stored in the database wherein the associated letter choice is a data value or a data symbol associated with the stored keystroke;
matching the beginning of the keystroke sequence with a stored keystroke sequence in a database, the stored keystroke sequence having associated word choices stored in the database wherein the associated word choice is a data value or a data symbol associated with the stored keystroke sequence;
displaying the matching letter choices associated with the keystroke;
displaying the matching word choices associated with the beginning keystroke sequence; and
performing as per a multi-character key input, if the character or multi-character key representing the character is inputted ambiguously.

22. A method of inputting of claim 21 further comprising the step:
inputting the beginning characters unambiguously using the keyboard;
inputting the following characters ambiguously using the keyboard;
matching the keystroke sequence or the beginning of the keystroke sequence with a stored keystroke sequence in a database, the stored keystroke sequence having associated word choices stored in the database wherein the associated word choice is a data value or a data symbol associated with the stored keystroke sequence;
displaying as text input the data value or data symbol with the same beginning characters assigned to the keystroke; and
displaying the matching word choices with the same beginning characters associated with the keystroke sequence.

23. A method of inputting of claim 1 wherein a choice of punctuations & symbols will be displayed on pressing a key or a combination of keys.

24. A method of inputting of claim 1 wherein a choice of numerals will be displayed on pressing a key or a combination of keys.

25. A letter choice and word choice text input system comprising:
a keyboard or text input detector;
a database for storing letter or word choice wherein the letter or word choice is a data value or data symbol associated with an input keystroke of the keys or an input keystroke sequence of the keys respectively;
a display for displaying the letter choices or word choices; and
a display for displaying the inputted text.

26. A letter choice and word choice text input system of claim 25 wherein the letter choice are accented or diacritic variations of the associated keystroke.

27. A letter choice and word choice text input system of claim 25 wherein the letter or word choices are displayed in a predetermined window or display area.

28. A letter choice and word choice text input system of claim 27 wherein the predetermined window or display area is in single or double rows.

29. A letter choice and word choice text input system of claim 28 wherein the double row is to separate letter choices and word choices or inputted text with choices

30. A letter choice and word choice text input system of claim 27 wherein the predetermined window or display area is on a screen input system and the letter or word choices can be selected directly from the screen.

31. A letter choice and word choice text input system of claim 27 wherein there is a key for cycling between choices.

32. A letter choice and word choice text input system of claim 27 wherein there is a key for cycling between list of choices if the letter or word choices are too much to display within the predetermined window or display area.

33. A letter choice and word choice text input system of claim 25 wherein the data stored is stored in the order of the most recently selected data to the least recently selected data.

34. A letter choice and word choice text input system of claim 25 wherein the letter and word choices are presented in fixed numbers or groups of fixed numbers.

35. A letter choice and word choice text input system of claim 34 wherein short-cuts are associated with the letter and word choices.

36. A letter choice and word choice text input system of claim 35 wherein an auxiliary key or shift key is used in concert with other keys to function as short-cuts.

37. A letter choice and word choice text input system of claim 36 wherein the auxiliary key or shift key can be sticky or pressed together with other keys to differentiate between the normal auxiliary or shift function and the short-cut function.

38. A letter choice and word choice text input system of claim 25 wherein the keyboard can be any text input system or virtual text input system.

39. A letter choice and word choice text input system of claim 38 wherein the keyboard is a reduced keyboard system.

40. A letter choice and word choice text input system of claim 39 wherein the beginning text can be entered unambiguously and then followed by ambiguous text inputting where only choices with the same starting text as the beginning unambiguous text input are displayed.

41. A letter choice and word choice text input system of claim 25 wherein a choice of punctuations & symbols will be displayed on pressing a key or a combination of keys.

42. A letter choice and word choice text input system of claim 25 wherein a choice of numerals will be displayed on pressing a key or a combination of keys.
